(19) United States
(12) Patent Application Publication
(10) Pub. No.: US 2023/0409965 A1
(43) Pub. Date: Dec. 21, 2023

(54) FEDRATED LEARNING SYSTEM AND METHOD USING DATA DIGEST

(71) Applicants: Inventec ( Pudong) Technology Corporation, Shanghai (CN); Inventec Corporation, Taipei (TW)

(72) Inventors: Chih-Fan HSU, Taipei (TW); Wei-Chao Chen, Taipei (TW); Ming-Ching Chang, Taipei (TW)

(21) Appl. No.: 18/084,810

(22) Filed: Dec. 20, 2022

(30) Foreign Application Priority Data
Jun. 15, 2022 (CN) 202210677971.4

(51) Int. Cl. G06N 20/00

(52) U.S. Cl. CPC G06N 20/00

(57) ABSTRACT

A federated learning method using data digest includes: sending a general model to multiple client devices by a moderator, generating encoded features according to raw data and performing a training procedure by each client device, wherein the training procedure includes “updating the general model to generate a client model, selecting at least two encoded features and at least two labels to compute a feature weighted sum and a label weighted sum, sending the feature weighted sum and the label weighted sum as a digest to the moderator and send update parameters of the client model”, and “determining an absent client and an present client among the client devices, generating a replacement model according to the general model and the absent client, generating an aggregation model according to the present client and the replacement model, and training the aggregation model to update the general model” by the moderator.

### CROSS-REFERENCE TO RELATED APPLICATIONS

This non-provisional application claims priority under 35 U.S.C. § 119(a) on Patent Application No(s). 202210677971.4 filed in China on Jun. 15, 2022, the entire contents of which are hereby incorporated by reference.

### BACKGROUND

### 1. Technical Field

The present disclosure relates to federated learning, and more particularly to a federated learning system and method using data digest.

### 2. Related Art

Federated Learning (FL) addresses many privacy and data sharing issues through cross-device and distributed learning via central orchestration. Existing FL methods mostly assume a collaborative setting among clients can tolerate temporary client disconnection from the moderator.

In practice, however, extended client absence or departure can happen due to business competitions or other non-technical reasons. The performance degradation can be severe when the data are unbalanced, skewed, or non-independent-and-identically-distributed (non-IID) across clients.

Another issue arises when the moderator needs to evaluate and release the model to the consumers. As private client data are not accessible by the moderator, the representative data would be lost when clients cease to collaborate, resulting in largely biased FL gradient update and long-term training degradation. The naive approach of memorizing gradients during training is not a suitable solution, as gradients become unrepresentative very quickly as iteration progresses.

Overall, current federated learning still fails to perform well in the following three scenarios in combinations: (1) unreliable clients, (2) training after removing clients, and (3) training after adding clients.

### SUMMARY

Accordingly, the present disclosure provides a federated learning system and method using data digest. This is a federated learning framework that can address client absence by synthesizing representative client data at the moderator. The present disclosure addresses the privacy issues introduced in the digest and proposes a feature-mixing solution to reduce the privacy concerns.

According to an embodiment of the present disclosure, a federated learning method using data digest comprises: sending a general model to each of a plurality of client devices by a moderator; executing a digest producer by each of the plurality of client devices to generate a plurality of encoded features according to a plurality of raw data; performing a training procedure by each of the plurality of client devices, wherein the training procedure comprises: updating the general model to generate a client model according to the plurality of raw data, the plurality of encoded features, a plurality of labels corresponding to the plurality of encoded features, and a present client loss function; selecting at least two of the plurality of encoded features to compute a feature weighted sum, selecting at least two of the plurality of labels to compute a label weighted sum, and sending the feature weighted sum and the label weighted sum to the moderator as a digest when receiving a digest request; and sending an update parameter of the client model to the moderator; determining an absent client and a present client among the plurality of client devices by the moderator; generating a replacement model according to the general model, the digest of the absent client and an absent client loss function by the moderator; performing an aggregation to generate an aggregation model according to the update parameter of the client model of the present client and an update parameter of the replacement model of the absent client by the moderator; and training the aggregation model to update the general model according to a moderator loss function by the moderator.

According to an embodiment of the present disclosure, a federated learning system using data digest comprises a plurality of client devices and a moderator. Each of the plurality of client devices comprises: a first processor configured to execute a digest producer to generate a plurality of encoded features according to a plurality of raw data, further configured to update a general model to generate a client model according to the plurality of raw data, the plurality of encoded features, a plurality of labels corresponding to the plurality of encoded features, and a present client loss function, and further configured to select at least two of the plurality of encoded features to compute a feature weighted sum and select at least two of the plurality of labels to compute a label weighted sum when receives a digest request; and a first communication circuit electrically connected to the first processor and configured to send the feature weighted sum and the label weighted sum as a digest and send an update parameter of the client model. The moderator is communicably connected to each of the plurality of client devices, and comprises: a second communication circuit configured to send the general model to each of the plurality of client devices; and a second processor electrically connected to the second communication circuit, wherein the second processor is configured to determine an absent client and a present client among the plurality of client devices, generate a replacement model according to the digest of the absent client and an absent client loss function, perform an aggregation to generate an aggregation model according to the update parameter of the client model of the present client and an update parameter of the replacement model of the absent client, and train the aggregation model to update the general model according to a moderator loss function.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of the federated learning system using data digest according to an embodiment of the present disclosure;

FIG. 2 is an architectural diagram of the digest producer and the client model according to an embodiment of the present disclosure;

FIG. 3 is a schematic diagram of computing the feature weighted sum according to an embodiment of the present disclosure;

FIG. 4 is an architectural diagram of the guidance producer and the replacement model according to an embodiment of the present disclosure;

FIG. 5 and FIG. 6 are overview diagrams of the federated learning system using data digest according to an embodiment of the present disclosure;

FIG. 7 is a flow chart of the federated learning method using data digest according to an embodiment of the present disclosure;

FIG. 8 is a detailed flow chart of the step in FIG. 7;

FIG. 9 is a detailed flow chart of the step in FIG. 8;

FIG. 10 is a detailed flow chart of a step in FIG. 7;

FIG. 11 is a detailed flow chart of a step in FIG. 7;

FIG. 12 is a detailed flow chart of the step in FIG. 7;

FIG. 13, FIG. 14, FIG. 15, and FIG. 16 show the effectiveness of the general model's accuracy in four training scenarios; and

FIG. 17 and FIG. 18 show the visualized guidance.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The detailed description of the embodiments of the present disclosure includes a plurality of technical terms, and the following are the definitions of these technical terms:
Client, the endpoint that contributes the data to join a distributed training or federated learning, also called “client device”.
Moderator, the service provider that collects the models from the clients to aggregate a general model for providing the service.
Raw data, the data that are held by a client and need to be protected, also called “private data”.
Digest, a sharable representation that can represent the raw data. No privacy concerns are included in the digest. The dimension of the digest is usually but not limited to lower than the raw data.
Guidance, the data to support model training with client absence. The domains of the guidance and the private data are usually the same.
Client model, the model owned by each client.
General model, the model owned by the moderator that is aggregated from the client models.
Stochastic Gradient Decent (SGD), an optimization process to update the parameters of a machine learning model based on predefined loss functions.
Federated learning (FL), a collaborative training framework to train a machine learning model without sharing client data to protect the data privacy.
Machine learning, a field of study that gives computers the ability to learn without being explicitly programmed.
Loss function: the objective functions of the optimizing process for training a machine learning model.
Differential Privacy (DP), DP is a rigorous mathematical definition of privacy. DP technologies allow sharing data information without expose any individual sample.

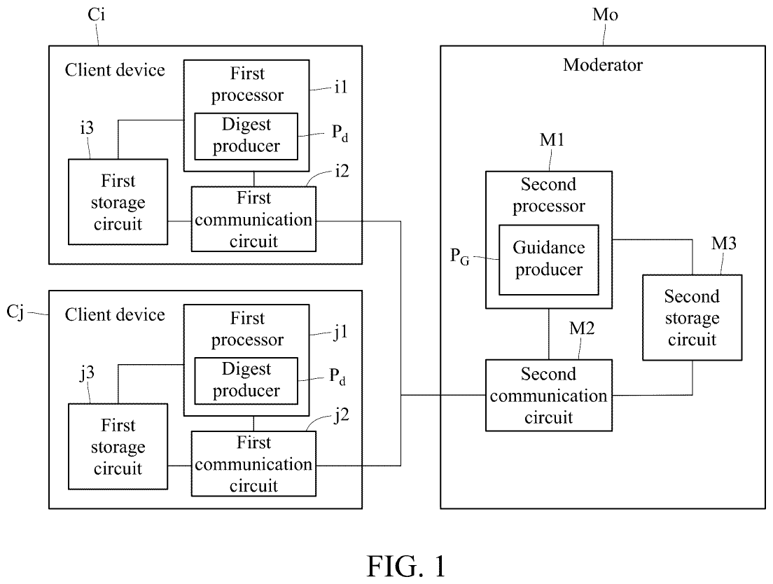

The present disclosure proposes a federated learning system using data digest (also called FedDig framework) and a federated learning method using data digest. FIG. 1 is a block diagram of the federated learning system using data digest according to an embodiment of the present disclosure. As shown in FIG. 1, the federated learning system using data digest includes a plurality of client devices Ci, Cj and a moderator Mo. The present disclosure does not limit the number of client device. For the convenient of illustration, FIG. 1 shows two client devices Ci, Cj as an example.

The hardware architecture of each of the client devices Ci, Cj is basically the same. The client device Ci in FIG. 1 is used as an example for illustration here, and the implementation example of the client device Cj can refer to the client device Ci. The client device Ci includes a first processor i1, a first communication circuit i2, and a first storage circuit i3. The first communication circuit i2 is electrically connected to the first processor i1. The first storage circuit i3 is electrically connected to the first processor i1 and the first communication circuit i2. In an embodiment, one of the following devices may be employed as the client device Ci: a server, a personal computer, a mobile computing device, and any electronic device for training a machine learning model.

The client device Ci is configured to collect raw data. The raw data include a private part and a non-private part other than the private part. For example, the raw data is an integrated circuit diagram, and the private part is a key circuit design in the integrated circuit diagram. For example, the raw data is a product design layout, and the private portion is the product logo. For example, the raw data is the text, and the private portion is the personal information such as name, phone, and address.

The first processor i1 is configured to execute a digest producer [symbol] , and thus generating a plurality of encoded features according to the plurality of raw data. In the embodiment shown in FIG. 1, the digest producer [symbol] is a software running on the first processor i1, however, the present disclosure does not limit the hardware configured to execute the digest producer [symbol] . The digest producer [symbol] may be stored in the first storage circuit i3 or an internal memory of the first processor i1.

In an embodiment, the federated learning system adopts an appropriate neural network model as the digest producer [symbol] according to the type of raw data. For example, EfficientNetV2 may be adopted as the digest producer [symbol] when the raw data is CIFAR-10 (CanadianInstitute for Advanced Research), and VGG16 may be adopted as the digest producer [symbol] when the raw data is EMINST (Extend Modified National Institute of Standards and Technology).

In an embodiment, the raw data is directly inputted to the digest producer [symbol] to generate the encoded features. In another embodiment, the first processor i1 preprocesses the private portion of the raw data before the raw data is inputted to the digest producer [symbol] . For example, when the raw data is an image, the preprocessing is to crop out the private portion from the image; when the private data is a text, the preprocessing is to remove the specified field or to mask the specific string. The digest producer [symbol] converts one piece of raw data into one encoded feature. In general, the dimention of raw data is greater than the dimension of encoded features.

If the number of samples of the raw data is K, after the digest producer [symbol] generates K encoded features according to the K pieces of raw data, the first processor it updates the general model from the moderator Mo to generate the client model according to the K pieces of raw data, K encoding features, K labels corresponding to the K encoding features, and a present client loss function.

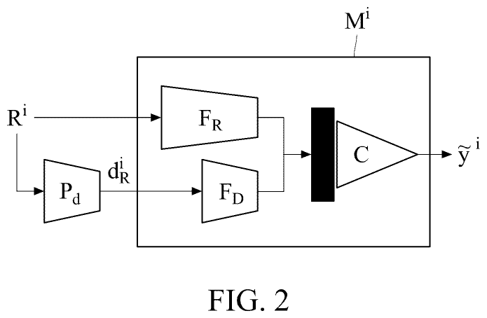

FIG. 2 is an architectural diagram of the digest producer and the client model according to an embodiment of the present disclosure. The client model includes a first feature extractor F_{R}, a second feature extractor F_{D}, and a classifier C. The present disclosure does not limit the implementation of the client model. For example, the neural network model such as EfficientNetV2 and VGG16 may be adopted as the client model. These neural network models themselves already include the design of the feature extractor (which can be used as the first feature extractor F_{R} mentioned above) and a classifier. As for the second feature extractor F_{D}, for example, feature extractors in neural network models such as ResNet, UNet, EfficientNet, and MobieNet may be used for implementation. As shown in FIG. 2, the first processor i1 inputs the plurality of raw data into the first feature extractor F_{R} respectively to generate a plurality of first features (the number of the raw data is equal to the number of first features), and inputs the plurality of raw data into the digest producer [symbol] to generate the plurality of encoded features. The first processor i1 inputs the plurality of encoded features to the second feature extractor F_{D} to generate the second feature, and inputs the concatenation of the first feature and the second feature to the classifier C to generate a predicted result \tilde{y}ⁱ. The first processor it further inputs the predicted result \tilde{y}ⁱ and an actual result yⁱ to a present client loss function, and adjusts a weight of at least one of the first feature extractor F_{R}, the second feature extractor F_{D}, and the classifier C according to an output of the present client loss function. In an embodiment, the present client loss function is shown in the following Equation 1:

[symbol]

= [symbol] _{ce}( [symbol] (Rⁱ,d_{R}ⁱ),yⁱ) (Equation 1),

where [symbol] is the present client loss function, [symbol] _{ce} is cross entropy, [symbol] is the client model of the client device Ci, Rⁱ is the raw data, d_{R}ⁱ is the encoded features, [symbol] (Rⁱ, d_{R}ⁱ)=\tilde{y}ⁱ represents the predicted result, and yⁱ is the actual result (also called label). The condition for the general model to complete training is that the output of the present client loss function [symbol] is smaller than a certain threshold. The general model [symbol] trained at the client device Ci is called the client model [symbol] and is sent to the moderator device Mo.

In addition, when the first communication circuit i2 receives a digest request from the moderator Mo, the first processor i1 is further configured to select at least two of the encoded features d_{R}ⁱ to compute a feature weighted sum, and select at least two of the labels yⁱ to compute a label weighted sum.

In an embodiment, the feature weighted sum is shown in the following Equation 2, and the label weighted sum is shown in the following Equation 3:

D_{R}=Σₖ₌₁^{SpD}wₖdₖ (Equation 2),

D_{y}=Σₖ₌₁^{SpD}wₖyₖ (Equation 3),

where D_{R} is the feature weighted sum, D_{y} is the label weighted sum, w k is the weight, dₖ is the encoded features, yₖ is the label, SpD represents the number of samples included in each digest (Samples per Digest). In other words, one digest D is a pair of the feature weighted sum D_{R} and the label weighted sum D_{y}. In an embodiment, the weight wₖ is set to an average value. For example, if SpD=4, then w₁=0.25, w₂=0.25, w₃=0.25, w₄=0.25. However, the present disclosure does not limit the setting of weights wₖ.

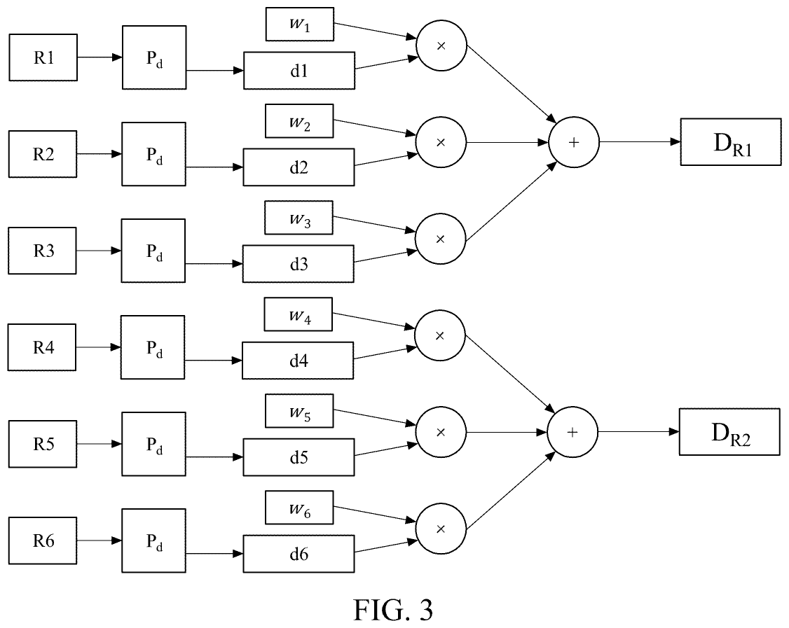

FIG. 3 is a schematic diagram of computing the feature weighted sum D R according to an embodiment of the present disclosure. In this embodiment, it is assumed that the number of samples of the raw data Rⁱ is 6 and SpD=3. As shown in FIG. 3, the digest producer [symbol] respectively generates 6 encoded features d1-d6 according to 6 pieces of raw data R1-R6.

The first processor it performs a multiplication on the 6 encoded features d1-d6 and 6 default weights w1-w6 respectively, then performs an addition on the 3 multiplication results corresponding to d1-d3 to generate the feature weighted sum D_{R1}, and performs an addition on the 3 multiplication results corresponding to d4-d6 to generate the feature weighted sum D_{R2}. The present disclosure does not limit how the first processor it selects a plurality of multiplication results that meet the SpD value to perform the addition. For example, in the example of FIG. 3, the first processor i1 may randomly select 3 multiplication results, such as the multiplication results corresponding to d1, d3, and d6, to perform the addition to generate the feature weighted sum D_{R1}, and then randomly select 3 multiplication results from the remaining multiplication results, such as the multiplication results corresponding to d2, d4, and d5, to perform the addition to generate the feature weighted sum D_{R2}. It should be noted that plurality of multiplication results being selected each time are not repeated. In other words, if the first processor it selects d1, d3, and d6 this time, d1, d3, and d6 that have been selected will not be selected again in subsequent selections. This approach ensures the security of the feature weighted sum D_{R}. If SpD does not divide the number of samples into integers, the remaining encoded features that are not selected are discarded.

In an embodiment, one of the following devices may be employed as the first processor i1: Application Specific Integrated Circuit (ASIC), Digital Signal Processor (DSP), Field Programmable Gate Array (FPGA), system-on-a-chip (SoC), and deep learning accelerator.

The first communication circuit i2 is configured to send the feature weighted sum D_{R} and the label weighted sum D_{y} as the digest D to the moderator Mo, and send an update parameter of the client model [symbol] to the moderator Mo. The first communication circuit i2 is further configured to receive the general model [symbol] and the updated general model from the moderator Mo. In an embodiment, the first communication circuit i2 performs the aforementioned transmission and reception tasks through a wired network or a wireless network.

The first storage circuit i3 is configured to store the raw data Rⁱ, the digest D, the general model [symbol] , and the client model [symbol] . In an embodiment, one of the following devices may be employed as the first storage circuit i3: Dynamic Random Access Memory (DRAM), Static Random Access Memory (SRAM), Double Data Rate Synchronuous Dynamic Random Access Memory (DDR SDRAM), flash memory, and hard disk.

The moderator Mo is communicably connected to each of the client devices Ci, Cj. The moderator Mo includes a second processor M1, a second communication circuit M2, and a second storage circuit M3. The second processor M1 is electrically connected to the second communication circuit M2, and the second storage circuit M3 is electrically connected to the second processor M1 and the second communication circuit M2. The hardware implementation of the moderator Mo and its internal components M1, M2, M3 may refer to the client devices Ci and its internal component i1, i2, i3, and thus the detail is not repeated here. The second processor M1 is configured to determine one or more absent client devices and one or more present devices among the plurality of client devices Ci, Cj. In an embodiment, the second processor M1 checks the communication connection between the second communication circuit M2 and each of the client devices Ci, Cj and thereby determining whether one or more of the client devices Ci, Cj is (are) disconnected. The client device Ci keeping the connection is called the present client, while the client device Cj breaking the connection is called the absent client.

The second processor M1 is configured to execute a guidance producer [symbol] , and thereby generating a piece of guidance G according to the digest D of the absent client. In the initial training stage of federated learning, each client device Ci, Cj converts the raw data R into the digest D and send the digest D to the moderator Mo. Therefore, the guidance G recovered from the digest D is equivalent to the representative part of the raw data R, and the guidance G does not include the privacy portion of the raw data R. When the moderator Mo updates the general model [symbol] , the guidance producer [symbol] is trained together with the general model [symbol] , and the detail is described later. In the embodiment shown in FIG. 1, the guidance producer [symbol] is a software running on the second processor M1, but the present disclosure does not limit the hardware configured to execute the guidance producer [symbol] . The guidance producer [symbol] may be stored in the second storage circuit M3, or in an internal memory of the second processor M1. Since the guidance producer [symbol] may generate the guidance G representing the raw data R of the client device Ci, the guidance producer [symbol] should be protected by the moderator Mo from undesired access by unauthorized clients, thereby avoiding potential data leakage or an adversarial attack.

In the initial training stage of federated learning, the second processor is further configured to initialize the general model [symbol] , and send the general model [symbol] to each of the client devices Ci, Cj through the second communication circuit M2. During the training progress of federal learning, if the second processor M1 determines absent client (such as Cj), the second processor M1 generates a replacement model according to the general model [symbol] , the digest D_{R}^{j} of the absent client Cj, and an absent client loss function.

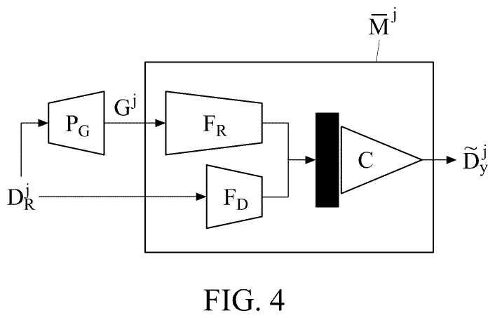

FIG. 4 is an architectural diagram of the guidance producer and the replacement model according to an embodiment of the present disclosure. The replacement model includes a first feature extractor F_{R}, a second feature extractor F_{D} and a classifier C. As shown in FIG. 4, the second processor M1 is configured to input the digest D_{R}^{j} of the absent client Cj to the guidance producer [symbol] to generate the guidance G, input the guidance G to the first feature extractor F_{R} to generate a first feature, input the digest D_{R}^{j} of the absent client Cj to the second feature extractor F_{D} to generate a second feature, and input a concatenation of the first feature and second feature to the classifier C to generate a predicted result [symbol] . The second processor M1 is further configured to input the predicted result [symbol] and an actual result D_{y}^{j} to the absent client loss function, and adjust a weight of at least one of the first feature extractor F_{R}, the second feature extractor F_{D} and the classifier C. In an embodiment, the absent client loss function is shown in the following Equation 4:

[symbol]

= [symbol] _{ce}( [symbol] ( [symbol] (D_{R}^{j}),D_{R}^{j}),D_{y}^{j}) (Equation 4),

where [symbol] is the absent loss function, [symbol] _{ce} is the cross entropy, [symbol] is the replacement model (assumed that the absent client is the client device Cj), [symbol] is the guidance producer, D_{R}^{j} is the digest corresponding to the absent client Cj, [symbol] (D_{R}^{j})=G^{j} represents the guidance, [symbol] ( [symbol] (D_{R}^{j}), D_{R}^{j})= [symbol] represents the predicted result of the replacement model [symbol] , D_{y}^{j} is the actual result. The condition for the replacement model [symbol] to complete training is that the output of the absent client loss function [symbol] is smaller than a certain threshold. The general model [symbol] completing the training is called the replacement model [symbol] .

Overall, if the client device is not an absent client, the client device may train the client model based on the general model and the raw data. In contrast, if the client device becomes an absent client, the moderator may train the general model on behalf of the absent client based on the digest representing the raw data to generate a replacement model. From FIG. 2 and FIG. 4, it can be seen that the client model and the replacement model have the same architecture because both models are trained based on the general model, the difference lies in the different input data.

The second processor M1 is further configured to perform an aggregation to generate an aggregation model according to the general model [symbol] , the update parameter of the client model [symbol] of the present client Ci and the update parameter of the replacement model [symbol] of the absent client Cj. In an embodiment, the update parameter of the model may be, for example, gradient or weight. In an embodiment, the aggregation is shown in the following Equation 5:

[symbol]

ₜ= [symbol] ₜ+Σᵢwₜⁱ∇ [symbol] ₜⁱ+Σⱼwₜ^{j}∇ [symbol] ₜ^{j} (Equation 5),

where [symbol] ₜ is the aggregation model, [symbol] ₜ is the general model (t represents the t-th iteration), wₜⁱ is the weight corresponding to the present client Ci, ∇ [symbol] is the update parameter of the client model [symbol] of the present client Ci, wₜ^{j} is the weight corresponding to the absent client Cj, ∇ [symbol] is the update parameter of the replacement model [symbol] of the absent client Cj.

In an embodiment, the weight wₜⁱ corresponding to the present Ci and the weight wₜ^{j} corresponding to the absent client Cj satisfy the following Equation 6:

Σᵢwₜⁱ+Σⱼwₜ^{j}=1 (Equation 6).

In other embodiments, the aggregation may be FedAvg, FedProx, or FedNova, and the present disclosure does not limit thereof.

The second processor M1 is further configured to train the aggregation model [symbol] ₜ to update the general model [symbol] according to the moderator loss function. In an embodiment, the moderator loss function is shown in the following Equation 7:

[symbol]

ₛₑᵣᵥₑᵣ= [symbol] _{ce}( [symbol] ₜ( [symbol] (D_{R}),D_{R}),D_{y}) (Equation 7),

where [symbol] ₛₑᵣᵥₑᵣ is the moderator loss function, [symbol] _{ce} is the cross entropy, [symbol] ₜ is the aggregation model, [symbol] is the guidance producer, D_{R} is the feature weighted sum of all client devices, D_{y} is the label weighted sum of all client devices. The condition for the aggregation model [symbol] ₜ to complete training is that the output of the moderator loss function [symbol] ₛₑᵣᵥₑᵣ is smaller than a certain threshold. In addition, in the training process that the output of the moderator loss function [symbol] ₛₑᵣᵥₑᵣ reduces, the training of the guidance producer [symbol] is also achieved at the same time.

The second communication circuit M2 is configured to send the general model [symbol] ₜ, the digest producer [symbol] to each of the client devices Ci, Cj. In other words, the moderator Mo and each of the client devices Ci, Cj have identical digest producer [symbol] . In addition, in the initial training stage of federated learning, the second processor M1 controls the second communication circuit M2 to send the digest request to each of the client devices Ci, Cj, and then to receive the digest D returned from each of the client devices Ci, Cj.

The second storage circuit M is configured to store digests D of all client devices Ci, Cj, and further store the digest producer [symbol] , the guidance G, the general model [symbol] ₜ, and the replacement model [symbol] .

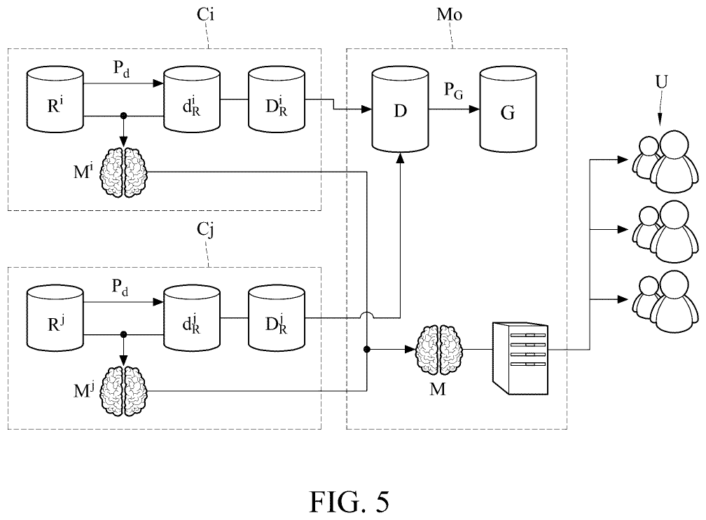

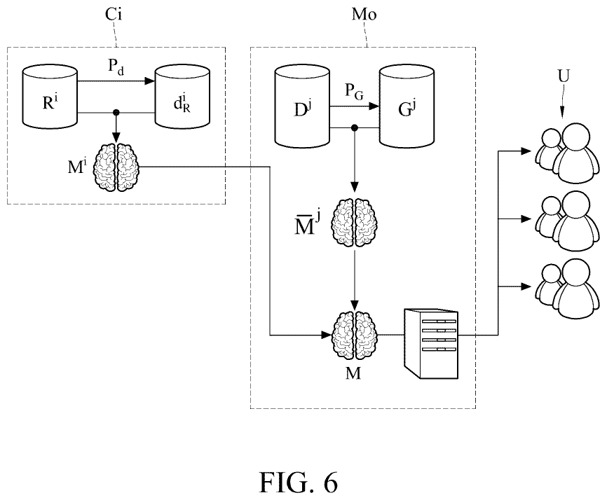

FIG. 5 and FIG. 6 are overview diagrams of the federated learning system using data digest according to an embodiment of the present disclosure. FIG. 5 and FIG. 6 represent two different timings in the training process respectively, and the timing corresponding to FIG. 6 is later than the timing corresponding to FIG. 5. FIG. 5 and FIG. 6 represent two conditions of FedDig training respectively, where FIG. 5 shows that system collects digests when a client is available and FIG. 6 shows that the system uses the guidance to continue training when a client is absent.

Before the timing corresponding to FIG. 5, the client device Ci has already received the general model [symbol] from the moderator Mo. At the timing corresponding to FIG. 5, the client devices Ci, Cj exist and perform the training respectively. Taking the client device Ci as an example, the digest producer [symbol] converts the plurlaity of raw data Rⁱ into the plurality of encoded features d_{R}ⁱ, mixes the plurlaity of encoded features d_{R}ⁱ to generate the digest D_{R}ⁱ, and sends the digest D_{R}ⁱ to the moderator Mo. The client device Ci performs the training according to the raw data Rⁱ, the encoded features d_{R}ⁱ and the general model [symbol] , and thereby generating the client model [symbol] . The operation of the clinent device Cj is identical to that of the client device Ci, and the description is not repeated here.

The moderator Mo receives the digests D_{R}ⁱ, D_{R}^{j} from the client devices Ci, Cj and stores thereof. The moderator Mo receives the update parameters of the client models [symbol] , [symbol] from the client devices Ci, Cj, performs the aggregation according to the update parameters of the client models [symbol] , [symbol] , and thereby updating the general model [symbol] . Finally, the trained general model [symbol] may be deployed on the device of the consumer U.

At the timing corresponding to FIG. 6, the client device Ci is the present client. The client device Cj leaves and becomes the absent client. Therefore, the guidance producer [symbol] of the moderator Mo generates the guidance G^{j} according to the digest D^{j} corresponding to the absent client Cj. The moderator Mo further generates the replacement model [symbol] according to the digest D^{j} corresponding to the absent client Cj and the guidance G′, performs the aggregation according to the replacement model [symbol] and client model [symbol] of the present client Ci, and thereby updating the general model [symbol] .

In this way, regardless of whether the client device Ci exists or not, the training of the federated learning system using data digest proposed by the present disclosure will not be interrupted.

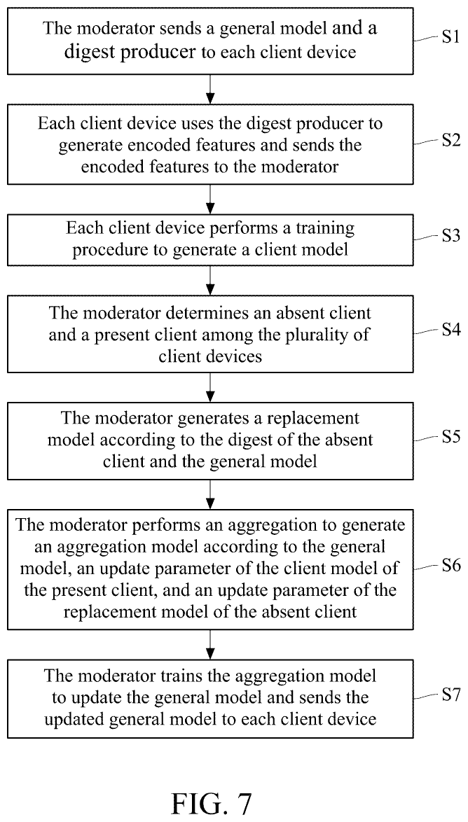

FIG. 7 is a flow chart of the federated learning method using data digest according to an embodiment of the present disclosure and includes steps S1-S7. Step S1 shows “the moderator sends a general model and a digest producer to each client device”, step S2 shows “each client device uses the digest producer to generate encoded features and sends the encoded features to the moderator”, step S3 shows “each client device performs a training procedure to generate a client model”, step S4 shows “the moderator determines an absent client and a present client among the plurality of client devices”, step S5 shows “the moderator generates a replacement model according to the digest of the absent client and the general model”, step S6 shows “the moderator performs an aggregation to generate an aggregation model according to the general model, an update parameter of the client model of the present client, and an update parameter of the replacement model of the absent client”, and step S7 shows “the moderator trains the aggregation model to update the general model and sends the updated general model to each client device”.

The training of federated learning includes a plurality of iterations, and steps S3-S7 in FIG. 7 show the detail of one of the iterations. In an embodiment, the method shown in FIG. 7 may be implemented by the system shown in FIG. 1, FIG. 5 and FIG. 6.

In an embodiment, step S1 is performed in the first iteration of federated learning. In step S1, the moderator initializes a general model, and sends the general model to each client device. In addition, the moderator sends the digest producer to each client device to ensure that all client devices have the identical digest producer. A fixed digest producer allows the digest generated by the client device to remain fixed in each iteration.

In step S2, each client device inputs the plurality of raw data into the digest producer to generate the plurality of encoded features, and selects some of the plurality of encoded features to mix according to the specified number, and thereby generating the digest to send to the moderator. In an embodiment, step S2 is performed in the first iteration of the federated learning. In other embodiment, step S2 is performed as long as the client device receives the digest request from the moderator.

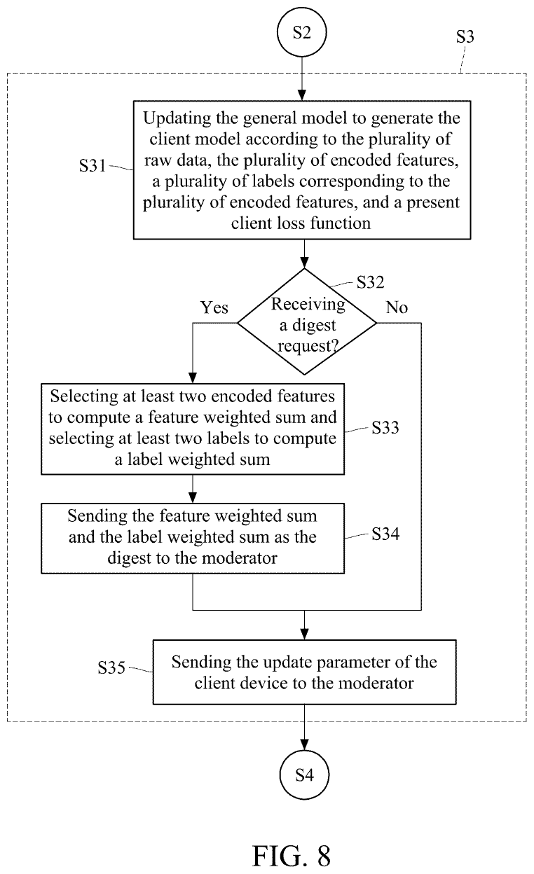

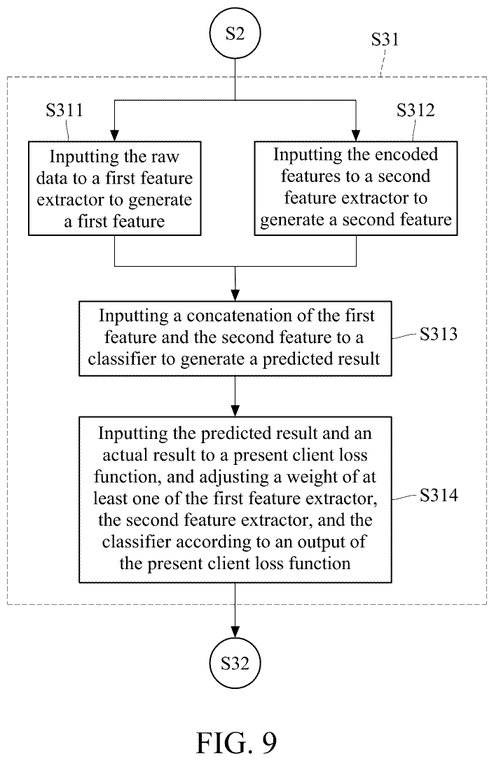

In step S3, the details of the training procedure may refer to FIG. 8. FIG. 8 is a detailed flow chart of step S3 in FIG. 7 and includes steps S31-35. In step S31, the client device updates the general model to generate the client model according to the plurality of raw data, the plurality of encoded features, a plurality of labels corresponding to the plurality of encoded features, and a present client loss function. Please refer to FIG. 9 for the details of step S31. FIG. 9 is a detailed flow chart of step S31 in FIG. 8 and includes steps S311-S314. Step S311 shows “inputting the raw data to a first feature extractor to generate a first feature”, step S312 shows “inputting the encoded features to a second feature extractor to generate a second feature”, step S313 shows “inputting a concatenation of the first feature and the second feature to a classifier to generate a predicted result”, and step S314 shows “inputting the predicted result and an actual result to a present client loss function, and adjusting a weight of at least one of the first feature extractor, the second feature extractor, and the classifier according to an output of the present client loss function”.

In step S32, the client device determines whether a digest request has been received. Step S33 is performed if the determination is “yes”. Step S35 is performed if the determination is “no”. In step S33, the client device selects at least two encoded features from the plurality of encoded features to compute a feature weighted sum and selects at least two labels from the plurality of labels to compute a label weighted sum. In step S34, the client device sends the feature weighted sum and the label weighted sum as the digest to the moderator. In step S35, the client device sends the update parameter of the client device to the moderator.

In step S4, the moderator detects the connection between itself and each client device, thereby classifying the client device that keeps the connection as a present client, and the client device that breaks the connection as an absent client.

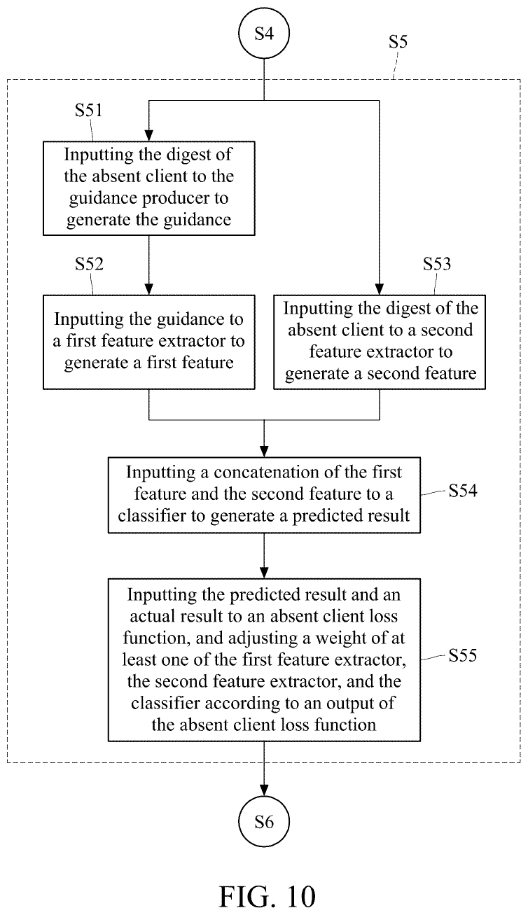

In step S5, the details of generating the replacement model may refer to FIG. 10. FIG. 10 is a detailed flow chart of a step S5 in FIG. 7 and includes steps S51-S55. Step S51 shows “inputting the digest of the absent client to the guidance producer to generate the guidance”, step S52 shows “inputting the guidance to a first feature extractor to generate a first feature”, step S53 shows “inputting the digest of the absent client to a second feature extractor to generate a second feature”, step S54 shows “inputting a concatenation of the first feature and the second feature to a classifier to generate a predicted result”, and step S55 shows “inputting the predicted result and an actual result to an absent client loss function, and adjusting a weight of at least one of the first feature extractor, the second feature extractor, and the classifier according to an output of the absent client loss function”.

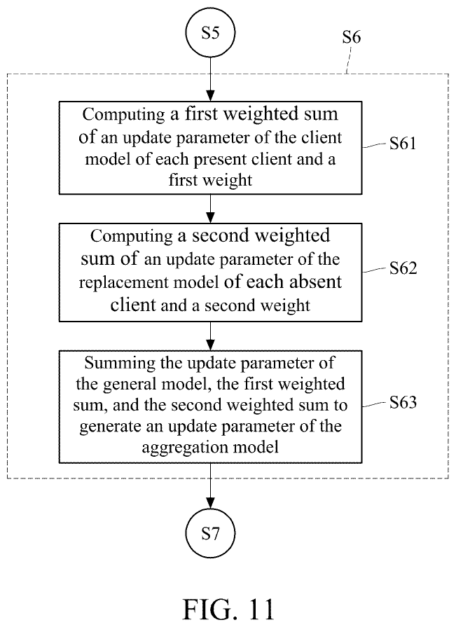

In step S6, the details of generating the aggregation model may refer to FIG. 11. FIG. 11 is a detailed flow chart of a step S6 in FIG. 7 and includes steps S61-S63. Step S61 shows “computing a first weighted sum of an update parameter of the client model of each present client and a first weight”, step S62 shows “computing a second weighted sum of an update parameter of the replacement model of each absent client and a second weight”, and step S63 shows “summing the update parameter of the general model, the first weighted sum, and the second weighted sum to generate an update parameter of the aggregation model”.

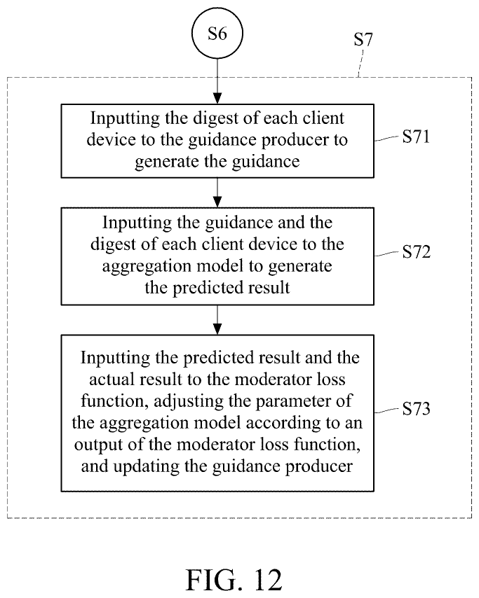

In step S7, the details of updating the general model may refer to FIG. 12. FIG. 12 is a detailed flow chart of a step S7 in FIG. 7 and includes steps S71-S73. Step S71 shows “inputting the digest of each client device to the guidance producer to generate the guidance”, step S72 shows “inputting the guidance and the digest of each client device to the aggregation model to generate the predicted result”, and step S73 shows “inputting the predicted result and the actual result to the moderator loss function, adjusting the parameter of the aggregation model according to an output of the moderator loss function, and updating the guidance producer”. After step S73 is completed, the trained aggregation model may be sent to each client device as the updated general model and is.

The following algorithm is the pseudo code of the federated learning method using data digest according to an embodiment of the present disclosure:

| | |
|---|---|
| 01 | Initialize: [symbol] and [symbol] |
| 02 | for Each training iteration t do |
| 03 | Moderator pushes current model [symbol] ₜ to all clients |
| 04 | Each client i generates encoded features d_{R}ⁱ from Rⁱ by digest producer [symbol] |
| 05 | for client i = 1, 2, ... , n in parallel do |
| 06 | Update [symbol] using raw data Rⁱ, encoded features d_{R}ⁱ, labels yⁱ, and loss |
| | [symbol] |
| 07 | if t = 0 then |
| 08 | Client i produces digests Dⁱ from d_{R}ⁱ and yⁱ via weighted sum |
| | with mixing parameter SpD and transmits Dⁱ to the moderator |
| 09 | Push model gradient [symbol] to the moderator |
| 10 | for absent client j = 1, 2, ... , k in parallel do (at the moderator) |
| 11 | Update [symbol] with using digests D^{j} with loss [symbol] _{client}^{absent} |
| 12 | Moderator aggregates [symbol] using weighted sum [symbol] of and [symbol] |
| 13 | Moderator updates [symbol] by jointly training [symbol] and [symbol] with loss [symbol] ₛₑᵣᵥₑᵣ |

where [symbol] is the general model, [symbol] is the guidance producer, t is the number of iterations, [symbol] ₜ is the general model at the t-th iteration, d_{R}ⁱ is the encoded feature, Rⁱ is the raw data, n is the number of client devices, [symbol] is the client model of present client Ci, yⁱ is the actual result (also called label), [symbol] is the present client loss function, Dⁱ is the digest of the present client Ci, SpD represents the number of encoded features per digest mix, [symbol] is the replacement model of the absent client Cj, D^{j} is the digest of the absent client, [symbol] is the absent client loss function, [symbol] ₜ is the aggregation model, ∇ [symbol] is the update parameter of the client model of the present client Ci, ∇ [symbol] is the update parameter of the replacement model of the absent client Cj, [symbol] is the updated general model, [symbol] ₛₑᵣᵥₑᵣ is the moderator loss function.

Please refer to FIG. 8-FIG. 12 and the algorithm above. The third line of the algorithm corresponds to step S1, the fourth line corresponds to step S2, the fifth to ninth lines correspond to step S3, where the sixth line corresponds to step S31, the seventh line corresponds to step S32, the eighth line corresponds steps S33-S34, and the ninth line corresponds to step S35. The tenth line corresponds to step S4, the eleventh line corresponds to step S5 (including steps S51-S54), and the twelfth line corresponds to step S6 (including steps S61-S63), and the thirteenth line corresponds to step S7 (including steps S71-S73).

In view of the above, the present disclosure provides a federated learning method using data digest. This is a federated learning framework that can address client absence by synthesizing representative client data at the moderator. The present disclosure proposes a data memorizing mechanism to handle the client's absence effectively. Specifically, the present disclosure handles the following three scenarios: (1) unreliable clients, (2) training after removing clients, and (3) training after adding clients.

The present disclosure deals with potential client absence during FL training is to encode and aggregate information of the raw data and corresponding labels as data digests. When clients leave, the moderator may recover information from these digests to generate training guidance that can mitigate the catastrophic forgetting caused by the absent data. Since digests may be shared and stored at the moderator for training use, information that can lead to data privacy infringement should not be recoverable from the digests. To increase privacy protection of the proposed data digest, the present disclosure introduces the sample disturbance by mixing features extracted from the raw data. Furthermore, the present disclosure introduces a trainable guidance producer into the ordinary FL training process, such that the moderator may learn to extract information and generate training guidance from the digests automatically. The digest and guidance proposed by the present disclosure are adaptable to most FL systems.

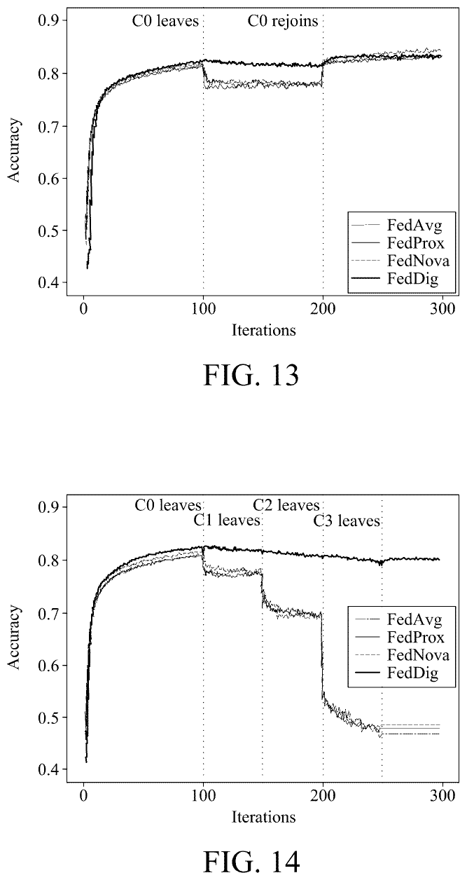

In the training process of FL, the following four training scenarios are common: (1) a client temporarily leaves during the FL training, (2) a client leaves the training forever, (3) all clients leave the FL training sequentially, and (4) multiple client groups join the FL training in different time slots. FIG. 13-FIG. 16 correspond to the above four scenarios respectively and show the accuracy of the general model, where C0, C1, C2, C3 represent different client devices. As it can be observed that none of the common FL algorithms, FedAvg, FedNova, FedProx, survive in the target four scenarios on the testing accuracy. On the other hand, the federated learning system and method using data digest achieve a stable testing accuracy on the scenarios. The experiment results show the robustness of the federated learning system and method using data digest.

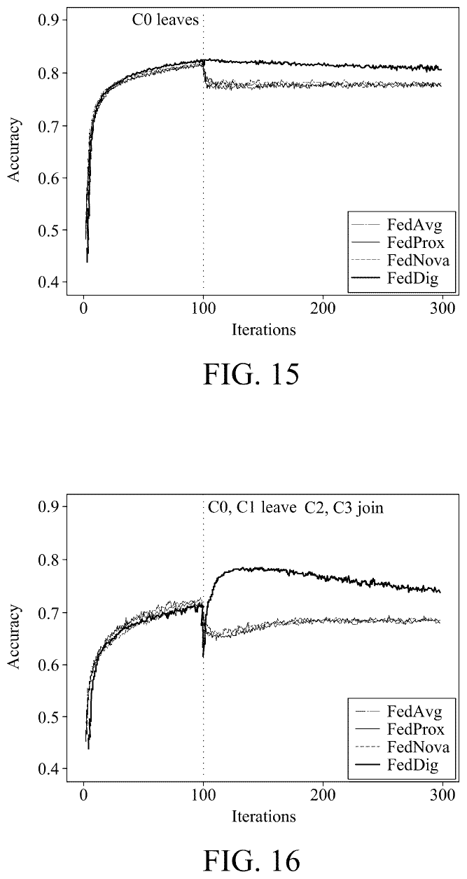

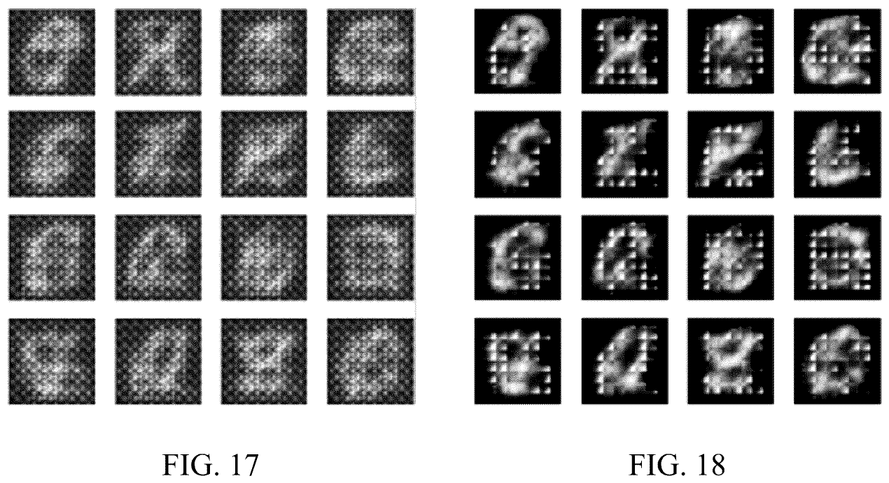

In FedDig, the moderator must transmit the digest producer [symbol] to participating clients for training use. If a malicious attacker can monitor the transmission and hack [symbol] to obtain its pseudo-inverse [symbol] , then in this case, data in the raw sample domain can be recovered using [symbol] . To test the ability of the FedDig against an attack on recovering samples from the digests and to investigate to what extent the feature-mixing digests proposed by the present disclosure can protect data privacy under malicious attacks, the present disclosure simulates this attack by training an autoencoder with the network structures of [symbol] and [symbol] . Specifically, the trained encoder is served as [symbol] and the trained decoder is served as the pseudo-inverse [symbol] , and then the present disclosure trains the guidance producer and the general model as the regular training process of FedDig with [symbol] , and visualize the guidance produced by [symbol] and [symbol] as shown in FIG. 17 and FIG. 18, where the raw data set is EMNIST. FIG. 17 shows the output obtained by inputting the digest to the guidance producer [symbol] . FIG. 18 shows the output obtained by inputting the digest to the pseudo-inverse [symbol] of the digest producer. It can be observed from FIG. 17 and FIG. 18 that no handwritten numerals are visually recognized. Although the guidance generated by [symbol] reveals several patterns on the EMNIST datasets, individual raw data are far from identifiable from these pattern-like samples.

The present disclosure also uses the CIFAR-10 data to repeat the above experiment. The experimental result shows that it cannot obtain a suitable [symbol] from training that is capable to recover raw data from the digest even if SpD is set to one. This result also suggests that training a pseudo-inverse function of a complex digest producer is not straightforward. Overall, recovering raw samples from the digest is difficult due to the permanent information loss during feature mixing.

What is claimed is:

1. A federated learning method using data digest comprising:
sending a general model to each of a plurality of client devices by a moderator;
executing a digest producer by each of the plurality of client devices to generate a plurality of encoded features according to a plurality of raw data;
performing a training procedure by each of the plurality of client devices, wherein the training procedure comprises:
updating the general model to generate a client model according to the plurality of raw data, the plurality of encoded features, a plurality of labels corresponding to the plurality of encoded features, and a present client loss function;
selecting at least two of the plurality of encoded features to compute a feature weighted sum, selecting at least two of the plurality of labels to compute a label weighted sum, and sending the feature weighted sum and the label weighted sum to the moderator as a digest when receiving a digest request; and
sending an update parameter of the client model to the moderator;
determining an absent client and a present client among the plurality of client devices by the moderator;
generating a replacement model according to the general model, the digest of the absent client and an absent client loss function by the moderator;
performing an aggregation to generate an aggregation model according to the update parameter of the client model of the present client and an update parameter of the replacement model of the absent client by the moderator; and
training the aggregation model to update the general model according to a moderator loss function by the moderator.

2. The federated learning method using data digest of claim 1, wherein the general model comprises a first feature extractor, a second feature extractor and a classifier, and updating the general model to generate the client model according to the plurality of raw data, the plurality of encoded features, the plurality of labels corresponding to the plurality of encoded features, and the present client loss function comprises:
inputting the plurality of raw data to the first feature extractor to generate a first feature;
inputting the plurality of encoded features to the second feature extractor to generate a second feature;
inputting a concatenation of the first feature and the second feature to the classifier to generate a predicted result; and
inputting the predicted result and an actual result to the present client loss function, and adjusting a weight of at least one of the first feature extractor, the second feature extractor, and the classifier according to an output of the present client loss function.

3. The federated learning method using data digest of claim 1, wherein the general model comprises a first feature extractor, a second feature extractor and a classifier, and generating the replacement model according to the digest of the absent client and the absent client loss function comprises:
inputting the digest of the absent client to a guidance producer to generate a piece of guidance;
inputting the piece of guidance to the first feature extractor to generate a first feature;
inputting the digest of the absent client to the second feature extractor to generate a second feature;
inputting a concatenation of the first feature and the second feature to the classifier to generate a predicted result; and
inputting the predicted result and an actual result to the absent client loss function, and adjusting a weight of at least one of the first feature extractor, the second feature extractor, and the classifier according to an output of the absent loss function; wherein the replacement model is the general model with an update weight.

4. The federated learning method using data digest of claim 1, wherein performing the aggregation to generate the aggregation model according to the update parameter of the client model of the present client and the update parameter of the replacement model of the absent client comprises:
computing a first weighted sum of the update parameter of the client model of the present client and a first weight;
computing a second weighted sum of the update parameter of the replacement model and a second weight, wherein a sum of the first weight and the second weight is a constant; and
summing a parameter of the general model, the first weighted sum and the second weighted sum to generate a parameter of the aggregation model.

5. The federated learning method using data digest of claim 1, wherein training the aggregation model to update the general model according to the moderator loss function by the moderator comprises:
inputting the digest of each of the plurality of client devices to a guidance producer to generate a piece of guidance;
inputting the piece of guidance and the digest of each of the plurality of client devices to the aggregation model to generate a predicted result; and
inputting the predicted result and an actual result to the moderator loss function, and adjusting a parameter of the aggregation model according to an output of the moderator loss function.

6. A federated learning system using data digest comprises:
a plurality of client devices, wherein each of the plurality of client devices comprises:
a first processor configured to execute a digest producer to generate a plurality of encoded features according to a plurality of raw data, further configured to update a general model to generate a client model according to the plurality of raw data, the plurality of encoded features, a plurality of labels corresponding to the plurality of encoded features, and a present client loss function, and further configured to select at least two of the plurality of encoded features to compute a feature weighted sum and select at least two of the plurality of labels to compute a label weighted sum when receives a digest request; and
a first communication circuit electrically connected to the first processor and configured to send the feature weighted sum and the label weighted sum as a digest and send an update parameter of the client model; and
a moderator communicably connected to each of the plurality of client devices, wherein the moderator comprises:
a second communication circuit configured to send the general model to each of the plurality of client devices; and
a second processor electrically connected to the second communication circuit, wherein the second processor is configured to determine an absent client and a present client among the plurality of client devices, generate a replacement model according to the general model, the digest of the absent client and an absent client loss function, perform an aggregation to generate an aggregation model according to the update parameter of the client model of the present client and an update parameter of the replacement model of the absent client, and train the aggregation model to update the general model according to a moderator loss function.

7. The federated learning system using data digest of claim 6, wherein the general model comprises a first feature extractor, a second feature extractor and a classifier, and the first processor is further configured to:
input the plurality of raw data to the first feature extractor to generate a first feature;
input the plurality of encoded features to the second feature extractor to generate a second feature;
input a concatenation of the first feature and the second feature to the classifier to generate a predicted result; and
input the predicted result and an actual result to the present client loss function, and adjusting a weight of at least one of the first feature extractor, the second feature extractor, and the classifier according to an output of the present client loss function.

8. The federated learning system using data digest of claim 6, wherein the general model comprises a first feature extractor, a second feature extractor and a classifier, and the second processor is further configured to:
input the digest of the absent client to a guidance producer to generate a piece of guidance;
input the piece of guidance to the first feature extractor to generate a first feature;
input the digest of the absent client to the second feature extractor to generate a second feature;
input a concatenation of the first feature and the second feature to the classifier to generate a predicted result; and
input the predicted result and an actual result to the absent client loss function, and adjusting a weight of at least one of the first feature extractor, the second feature extractor, and the classifier according to an output of the absent loss function; wherein the replacement model is the general model with an update weight.

9. The federated learning system using data digest of claim 6, wherein the second processor is further configured to:
compute a first weighted sum of the update parameter of the client model of the present client and a first weight;
compute a second weighted sum of the update parameter of the replacement model and a second weight, wherein a sum of the first weight and the second weight is a constant; and
sum a parameter of the general model, the first weighted sum and the second weighted sum to generate a parameter of the aggregation model.

10. The federated learning system using data digest of claim 6, wherein the second processor is further configured to:
input the digest of each of the plurality of client devices to a guidance producer to generate a piece of guidance;
input the piece of guidance and the digest of each of the plurality of client devices to the aggregation model to generate a predicted result; and
input the predicted result and an actual result to the moderator loss function, and adjusting a parameter of the aggregation model according to an output of the moderator loss function.
